(19) United States
(12) Patent Application Publication
(10) Pub. No.: US 2003/0024443 A1
(43) Pub. Date: Feb. 6, 2003

(54) Loading and unloading pallet, forming material and method of producing it

(75) Inventor: Shigeru Hoshi, Takasaki-shi (JP)

Correspondence Address: IPSOLON LLP, 805 SW BROADWAY, #2740, PORTLAND, OR, 97205, US

(73) Assignee: Kabushiki Kaishi Togiya

(21) Appl. No.: 10/186,767

(22) Filed: Jul. 1, 2002

(30) Foreign Application Priority Data
Jul. 27, 2001 (JP) 2001-228292

(51) Int. Cl. B65D 19/00; B29C 43/02

(52) U.S. Cl. 108/51.11; 264/122

(57) ABSTRACT

A plate-like or block-like material for forming a pallet for loading and unloading, containing a large number of wood chips impregnated with thermosetting resin and joined with each other through the thermosetting resin and thermoplastic resin filling gaps among said wood chips, wherein the volume ratio of said wood chips and said thermoplastic resin is 1:1.

### BACKGROUND OF THE INVENTION

1. Field of the Invention

The present invention relates to a pallet for loading and unloading, a plate-like or block-like material used for forming the pallet, and a method of producing the material.

2. Description of Prior Art

Heretofore, a wood board is used to form a pallet for loading and unloading. A wood board has favorable characteristics such as mechanical strength like flexural strength, stability, lightweight property and the like, which are required for a load-receiving pallet.

The wood board has, however, a weak point with respect to the direction of its fibers in that it is prone to be cracked along the borders of the fibers. Therefore, a board elongated in the extending direction of the fibers is used as a plate material constituting the pallet. However, when the front end of a fork of a forklift hooks the composing board (top deckboard) due to pushing or pulling of the loaded pallet on a floor surface and subjected to an upward concentrated load, the composing board tends to be cracked along its fibers, so that frequent exchanges of the board are required.

In order to avoid such inconveniences, as a composing material of a pallet in place of a wood board, use of a plate material having a performance equivalent to the wood board and also without the weak points of the wood board is under consideration.

As one of such plate materials, a material containing a large number of wood chips impregnated with thermosetting resin is taken into consideration (Japanese Patent Appln. Public Disclosure (KOKAI) No. 8-296202 and No. 10-231156).

The material described in KOKAI No. 8-296202 contains a large number of wood chips joined with gaps between each other. These wood chips are impregnated with thermosetting resin and joined together through the thermosetting resin.

Being composed mostly of the wood chips, this material is lightweight, has suitable elasticity, and suitable rigidity, because it is reinforced with the thermosetting resin with which the wood chips are impregnated. On the other hand, however, since it is a coat of the thermosetting resin that joins the wood chips together, the flexural strength of this material is relatively low.

On the other hand, the material (resin concrete) provided for the use of a pavement plate, architectural flooring, curb stone and the like as described in KOKAI No. 10-231156 comprises thermoplastic resin containing a large number of wood chips impregnated with thermosetting resin as aggregate and has a higher flexural strength. However, being mostly composed of the thermoplastic resin, this material has such a property as tends to be subjected to plastic deformation under a load and is hard to be restored to its original state.

### SUMMARY OF THE INVENTION

An object of the present invention lies in providing a material replaceable with a wood board for forming a loading and unloading pallet, a method of producing it, and a pallet made of the material.

A plate-like or block-like material for forming the loading and unloading pallet of the present invention contains a large number of wood chips impregnated with thermosetting resin and joined through the thermoplastic resin, in which the ratio by volume of the wood chips and the thermoplastic resin is 1:1.

Preferably, the wood chips have a dimension of about 20-30 mm in length, about 3-5 mm in width, and about 3-5 mm in height. Further preferably, the fibers of the wood chips extend in their longitudinal direction. The thermoplastic resin is preferably made of thermoplastic resin refuse.

The material for forming the loading and unloading pallet can be obtained by putting into a form a mixture of a large number of wood chips impregnated with thermosetting resin and a large number of particles made from the thermoplastic resin of which the volume ratio is 1:1, applying heat and pressure (i.e., hot pressing) to the mixture, and then, removing the molding from the form. Preferably, the mixture is put into the preliminarily heated form.

Since in the material for forming the loading and unloading pallet of the present invention gaps among a large number of wood chips impregnated with the thermosetting resin and mutually joined through the thermosetting resin are filled with the thermoplastic resin, it is featured by the lightweight in general, elasticity, and efficiency in mechanical strength such as flexural strength. The material for forming the pallet of the present invention which has such features is suitable for a composing material of a pallet.

Furthermore, in the material for forming the pallet of the present invention, a large number of wood chips in the inside face various directions and do not have any weak point in strength in terms of a specific direction like in a wood board. Therefore, the material of the present invention resists well a load in an arbitrary direction and does not crack with respect to a specific direction. In particular, the material for forming, when selectively using the wood chips whose longitudinal direction coincides with the extending direction of their fibers, has a higher mechanical strength than wood chips whose fibers extend widthwise.

Accordingly, when a pallet formed by the material of the present invention is in a loaded state, and when the front end of a fork of a forklift hooks the composing material, such a crack as in the aforementioned wood board will not occur in the composing material.

Also, according to the present invention, scraps of a wooden pallet, wooden scraps of a building and thermoplastic resin scraps can be abundantly used as raw materials of the wood chips, which also suits useful recycling of the product.

The forming material according to the present invention can be obtained, for example, by putting into a form a mixture of a large number of wood chips composed of crushed wooden scraps impregnated with thermosetting resin and a large number of thermoplastic resin particles composed of similarly crushed plastic scraps of the same volume as the wood chips, applying hot pressing to the mixture, and then, removing the molding from the form. Proper selection of the thermoplastic resin as a kind of the particles to be mixed enables to obtain a resin reinforced wood product higher in mechanical strength.

### BRIEF DESCRIPTION OF THE DRAWINGS

FIG. 1 is a partial perspective view of a pallet formed with a pair of plate-like members, which is an example of the pallet forming material according to the present invention.

FIG. 2 is a schematic enlarged sectional view of the pallet forming material.

FIG. 3 is a further enlarged schematic sectional view of the pallet forming material.

FIG. 4 is a schematic vertical section of a mixture of the wood chips and thermoplastic resin particles in a state of being put into a metal mold.

FIG. 5 is a schematic vertical section of a mixture of the wood chips and thermoplastic resin particles within a metal mold under application of hot pressing.

FIG. 6 is a schematic vertical section of a mixture of the wood chips and thermoplastic resin particles within a metal mold under further application of hot pressing.

### PREFERRED EMBODIMENT OF THE INVENTION

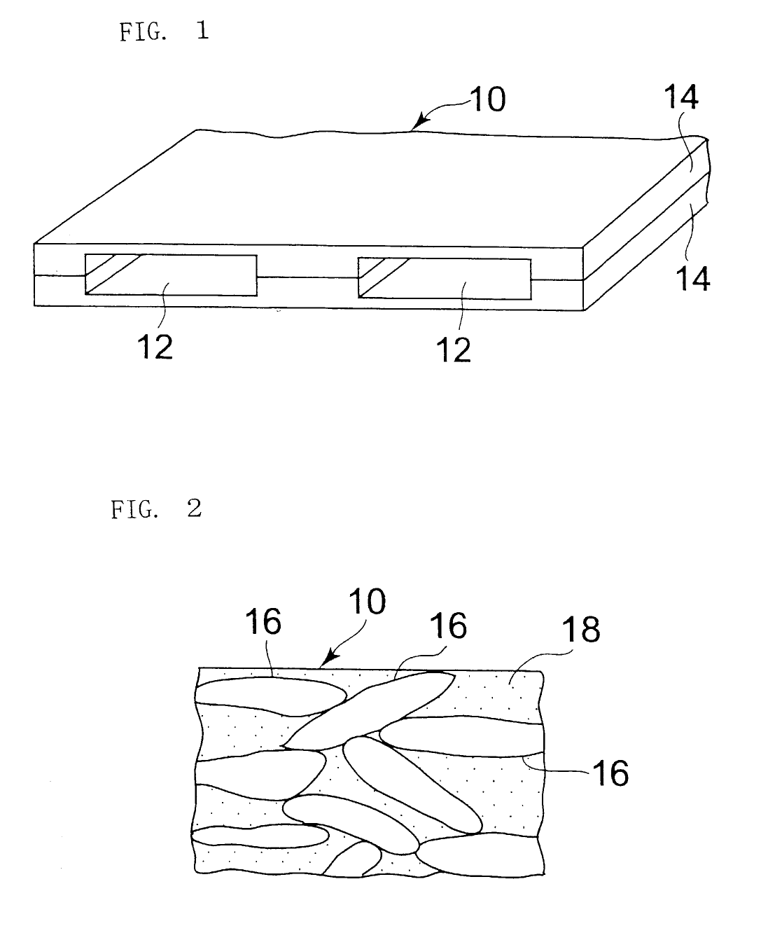

Referring to FIG. 1, a pallet to be used for loading according to the present invention is generally shown by reference numeral 10.

The pallet 10 as shown is formed by joining a pair of plate-like members 14 having a symmetrical cross section between the upper and lower halves and has a pair of inlets 12 for receiving a pair of forks (not shown) of a forklift.

Each plate-like member 14 composing the pallet 10, as shown in FIG. 2, is mostly made of a numerous wood chips 16 joined together, and small gaps among these wood chips 16 are filled with thermoplastic resin 18.

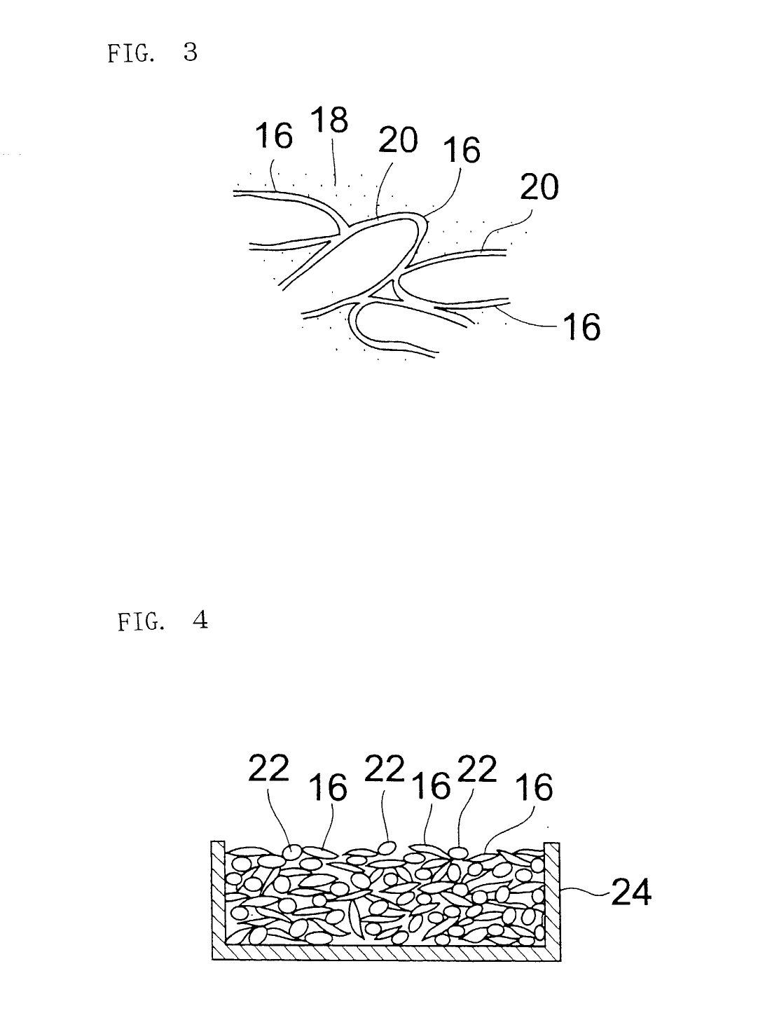

The wood chips 16, impregnated with thermosetting resin 20 (FIG. 3) such as unsaturated polyester resin, are efficient in water resistance, mechanical strength and the like, in comparison with non-impregnated ones. As the thermosetting resin 20, not only the unsaturated polyester resin but also phenol resin, urea resin, epoxy resin or the like can be used.

As shown in FIG. 3, a large number of wood chips 16 are joined together in part of their surfaces through the thermosetting resin 20.

The extent of impregnation with the thermosetting resin 20 does not matter if at least the whole surfaces of the wood chips 16 are covered. Therefore, either wood chips 16 impregnated with the thermosetting resin 20 to the core or those only superficially impregnated will do.

The thermosetting resin-impregnated wood chips 16 can be obtained by agitating and mixing with a mixer the wood chips and the thermosetting resin at a weight ratio of, e.g., 100:30.

The wood chips 16 can be obtained by crushing a deteriorated wood pallet, architectural wood scraps and the like, thereby contributing to an effective utilization of such scraps. Of course, it is possible to obtain wood chips by crushing unused timber. The wood chips 16 have a dimension of, for example, about 20-30 mm in length and 3-5 mm respectively in width and height. The wood chips 16 are preferably obtained by chipping the wood scraps or timber so as to coincide their longitudinal direction with the direction of their fibers. Such wood chips have long fibers and are efficient in flexural strength in comparison with wood chips chipped so as to coincide in their longitudinal direction with the direction perpendicular to the direction of the fibers.

Also, as the thermosetting resin, unsaturated polyester resin containing, for example, 30% by weight of styrene monomer (cross linking agent) is used. To this unsaturated polyester resin, 3% by weight of benzoyl peroxide (catalyst) is added as a curing time adjustor so as to coincide the curing time of the resin with the time for thermally melting the thermoplastic resin particles to be described later.

In place of the example of agitating and mixing with a mixer, the wood chips 16 impregnated with thermosetting resin can be obtained by spraying on the surface of the wood chips 16 with atomized unsaturated polyester resin liquid containing the catalyst, or by immersing the wood chips 16 in unsaturated polyester resin liquid containing the catalyst.

A process of producing the plate-like pallet-forming material is shown in FIGS. 4-6.

Firstly, a mixture of a large number of wood chips 16 impregnated with thermosetting resin and a large number of thermoplastic particles 22 is put into a metal mold 24 as a form. The metal mold 24 as shown has a flat bottom to obtain a plate-like material or a block, but to obtain a plate member 14 which is the material forming the pallet 10 shown in FIG. 1, a metal mold (not shown) having a rugged bottom face defining the rugged face of the plate-like member 14 of the pallet is used.

The thermoplastic resin particles 22 can be obtained as in case of the wood chips 16 by crushing plastic scraps. This contributes to effective utilization of the plastic scraps. Of course, the particles 22 may be so-called unused thermoplastic resin pellets, not crushed scraps, as in case of the wood chips 16. These crushed materials or pellets include a mixture of one or more of acrylonitrile butadiene styrene resin (ABC resin), polypropylene, polyethylene, polyvinyl chloride, polystyrene and the like.

The mixture of the wood chips 16 impregnated with the thermosetting resin and the particles 22 can be obtained by agitating and mixing the wood chips 16 and the particles 22 with a mixer, for example, at the weight ratio of 1:1 (or at the specific volume of 1:1 to 2:1).

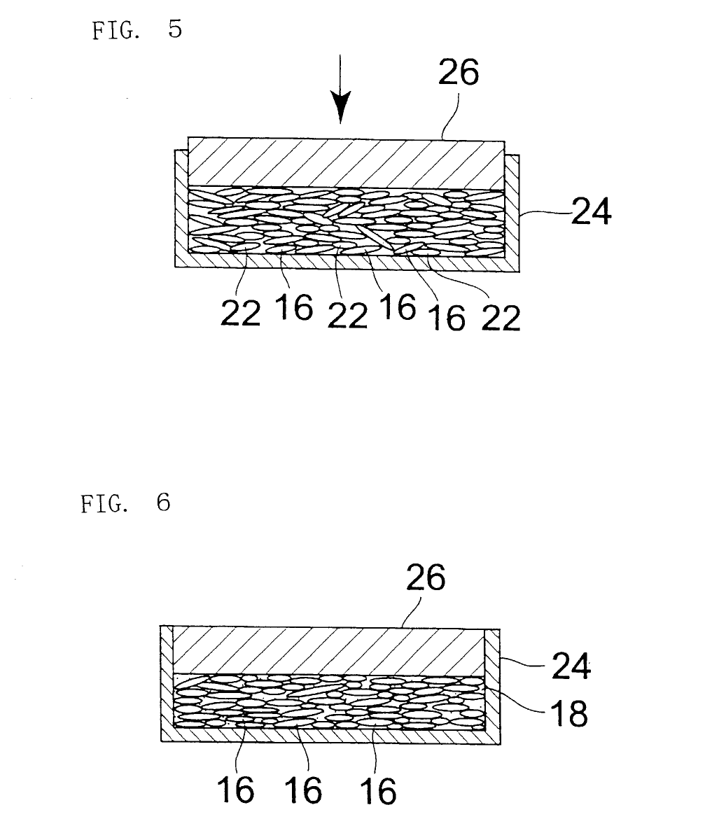

Thereafter, heat and pressure (i.e., hot pressing) is applied to the mixture of the chips 16 and the particles 22 within the metal mold 24 (see FIG. 5), thereby hardening the thermosetting resin impregnated in the wood chips 16 and heat-melting the particles 22 (see FIG. 6).

The hot pressing is applied, for example, by mounting on a hot press (not shown) the metal mold 24 and a block-like metal cover 26 to be fitted on the inner periphery of the metal mold, and by slowly lowering the cover 26 inside the metal mold 24 while actuating the hot press to heat the metal mold 24 and the cover 26. By slowly lowering the cover 26, the volume of the mixture of the chips 16 and the particles 22 within the metal mold 24 gradually decreases, during which time the air is let out of the mixture.

Heat is transmitted to the mixture within the metal mold 24 while subjected to the pressure of the cover 26 through the metal mold 24 and the cover 26. The heating temperature of the metal mold 24 and the cover 26 is set at, for example, about 180° C. on the average, though depending on the heat-melting temperature of the thermoplastic resin particles 22. The pressing force and the time for hot pressing the cover 26 are set respectively at about 5 to 10 kg/cm² and about 5 minutes.

In order to cause heat-melting of the particles 22 in the mixture within a shorter time so as to enhance efficiency in the use of the hot press, it is desirable to preheat the metal mold 24. The heating temperature is preferably 100° C.

In order to lower the cover 26 to the lowest position, the pressing force and the hot pressing time to the cover 26 are respectively set at about 10 to 20 kg/cm² and about 5 minutes. As a result, the thermosetting resin 20 impregnated in the wood chips 16 hardens under action of the catalyst at the temperature of about 100° C., and the wood chips 16 adjacent to one another are joined through the thermosetting resin 20, while the heat-melted material of the particles 22 flows into the gaps among the wood chips 16 to fill up the gaps.

Thereafter, while maintaining the pressing force (of about 10 to 20 kg/cm²), the metal mold 24 and the cover 26 are cooled. The material according to the present invention is obtained by removing the molding from the form after cooling.

The thermoplastic resin 18 filling the gaps among a number of mutually joined wood chips 16 serves to enhance the mechanical strength, especially, flexural strength of the resin hardened wood product itself.

The pallet forming material as a plate-like molding can be used as a substitute for a wood board in an existing wood pallet. With this, a pallet like the existing wood pallet can be formed by using a plurality of plate-like forming materials, and a broken wood plate of the wood pallet can be replaced with one or more plate-like forming materials.

The following table shows the values resulted from a test on the plate-like pallet forming materials according to the present invention (A), the conventional plate-like material (KOKAI No. 10-231156) (B) and the wood board (C), for confirming the characteristics thereof.

| | (A) Material of | (B) Conventional | (C) Wood board |
|---|---|---|---|
| | this invention | material | (Japanese larch) |
| (1) Flexural | 398 | 314 | 524 |
| strength 1 | | | |
| (kgf/cm²) | | | |
| (2) Stability | 0.00 | 0.05 | 0.3 |
| (cm, %) | 0 | 0.5 | 3 |
| (3) Weight (g) | 1,756 | 1,948 | 1,606 |
| (4) Flexural | 418 | 356 | 58 |
| strength 2 | | | |
| (kgf/cm²) | | | |

In the table, (1) shows the values obtained by supporting each of the plate materials (A), (B) and (C) having a dimension of 60 cm in length×15 cm in width×2.2 cm in thickness at a span of 48 cm, and applying a concentrated load on the center line crossing widthwise (as regards the wood board, in the extending direction of the fibers).

In the table, (2) shows the amounts of compression (strain) obtained by applying for 3 minutes a dead load of 4000 kg on the whole side faces of each of the plate materials (A), (B) and (C) having a dimension of 20 cm in length×5 cm in width×10 cm in thickness, and measuring 30 minutes after the application.

The volume ratio of the ingredients of each of plate materials (A) and (B) and the moisture content of the plate material (C) in (1) and (2) in the table are as follows:

Plate material A thermoplastic resin:wood chips=45:55

Plate material B thermoplastic resin:wood chips=90:10

Plate material C moisture content: 15%

In the table, (3) shows the weight of each plate material having the dimension as shown in (1).

In the table, (4) shows the values obtained by supporting each plate material having a dimension of 15 cm in length×15 cm in width×2.2 cm in thickness for the convenience' sake of a tester at a span of 15 cm, and applying a concentrated load on a line crossing in the longitudinal direction the widthwise center (as regards the wood board, in the direction orthogonal to the fibers).

It is understood from the above test values that, compared with the conventional plate material, the plate material (A) of the present invention is close to the characteristics of the wood board (C) with respect to any of the flexural strength 1 and 2, stability and weight, and besides, has no directionality to deformation which is a weak point of the wood board (see the flexural strength 1 and 2).

What is claimed is:

1. A plate-like or block-like material for forming a pallet for loading and unloading, containing a large number of wood chips impregnated with thermosetting resin and joined with each other through the thermosetting resin and thermoplastic resin filling gaps among said wood chips, wherein the volume ratio of said wood chips and said thermoplastic resin is 1:1.

2. A material as claimed in claim 1, wherein said wood chips have a dimension of about 20-30 mm in length, about 3-5 mm in width, and about 3-5 mm in height.

3. A material as claimed in claim 1, wherein the fibers of said wood chips extend in their longitudinal direction.

4. A material as claimed in claim 2, wherein the fibers of said wood chips extend in their longitudinal direction.

5. A material as claimed in claim 1, wherein said thermoplastic resin contains thermoplastic scraps.

6. A loading and unloading pallet formed by using the material described in claim 1.

7. A method of producing a material for forming a loading and unloading pallet, comprising the steps of:
putting into a form a mixture of a large number of wood chips impregnated with thermosetting resin and a large number of thermoplastic resin particles, of which the volume ratio is 1:1, applying heat and pressure to said mixture, and then, removing the molding.

8. A method as claimed in claim 7, wherein said mixture is put into said form which is preheated.
